(19) United States
(12) Patent Application Publication
(10) Pub. No.: US 2003/0180040 A1
(43) Pub. Date: Sep. 25, 2003

(54) Precision platen for a super-8-film cartridge

(76) Inventor: Gottfried Klose, Bielefeld (DE)

Correspondence Address: Harold V. Stotland, Seyfarth Shaw, Suite 4200, 55 East Monroe Street, Chicago, IL, 60603-5803, US

(21) Appl. No.: 10/390,232

(22) Filed: Mar. 17, 2003

(30) Foreign Application Priority Data
Mar. 15, 2002 (DE) 202 04 191.3

(51) Int. Cl. G03B 17/26

(52) U.S. Cl. 396/512

(57) ABSTRACT

A precision platen for a film cartridge including a cartridge platen biassed by a spring force so as to urge a film against a film platform of a film camera. The precision platen is of a design such that it is manually insertable into said film cartridge between said cartridge platen and said film in order to provide for planar engagement and precise guidance of the film along the film platform of the film camera.

### FIELD OF THE INVENTION

This invention relates to film cartridges and in particular to a precision platen for a super-8-film cartridge.

### DESCRIPTION OF THE PRIOR ART

As is well known super-8-film cartridges each include a platen which is disposed in the area of the cartridge opening. The platen is biassed by spring force outwards such that it urges the film against a film platform of a film camera when the film cartridge has been inserted into the film camera. The cartridge platen is formed, similar to the remaining film cartridge, as an injection molded plastic member having a contact side with ribs and depressions therebetween. Due to this structure and due to manufacturing tolerances the cartridge platen is positioned relative to the film platform of the film camera with play of 3/100 to 4/100 mm. This results in a certain film jittering effect causing unsteadiness of the film pictures and non-uniform focussing of the pictures when the film is running through the film camera.

### SUMMARY OF INVENTION

The present invention attempts to overcome this problem. More particularly, it is a general object of the present invention to provide a precision platen which ensures more precise contact and guidance of the film on and along the film platform of the film camera.

In accordance with the present invention a precision platen additional to the cartridge platen is provided, with the precision platen being of a design such that it may be manually inserted into the film cartridge between the cartridge platen and the film. This results in planar contact and precise guidance of the film on and along the film platform of the film camera.

Preferably the precision platen is a high precision hard-chrome plated brass plate. It has a front side comprising a planar contact surface for engagement with the film, and a back side including at least one rib which projects into a respective depression of the cartridge platen when the film cartridge and the precision platen have been inserted into the film camera.

Precise contact and guidance of the film on and along the film platform of the film camera results in dramatically improved picture steadiness both in horizontal and vertical directions. Furthermore uniform picture focussing will be provided across the total film width; lack of precise focussing along the edges is no longer observed. The film is running very smoothly, i.e. the jittering effect of the film as observed in the prior art is no longer present. The present invention is particularly advantageous for high speed operation (e.g. 80 pictures per second) so as to provide for precisely focussed pictures.

### BRIEF DESCRIPTION OF THE DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

FIG. 1 is a side elevational view of a precision plate of the present invention;

FIG. 2 is an elevational view from above of the precision platen in FIG. 1;

FIG. 3 is a front elevational view of the precision platen in FIG. 1.

### DETAILED DESCRIPTION OF THE PREFERRED EMBODIMENT

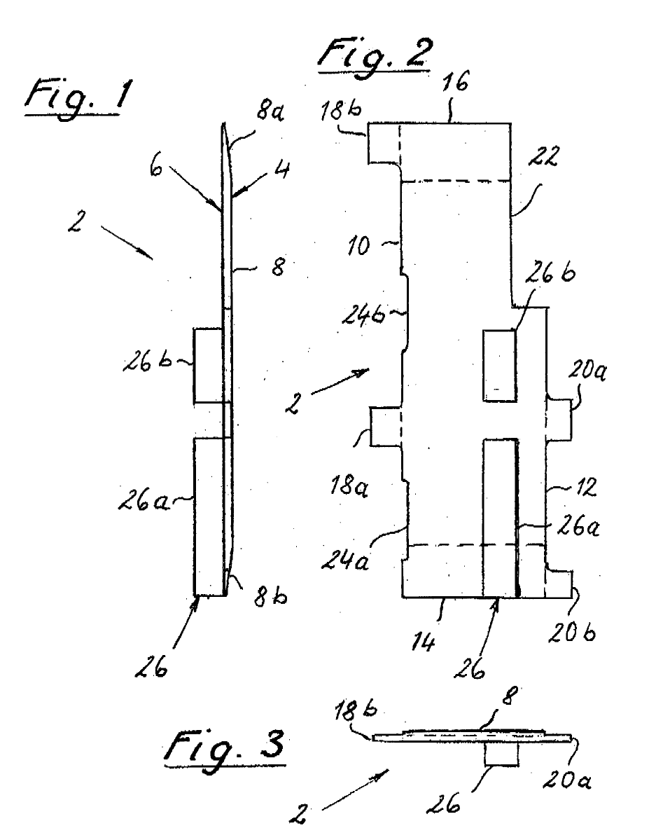

Referring to FIGS. 1 to 3 a precision platen 2 shown therein is intended to be used as an additional platen for a super-8-film cartridge (not shown) including its own platen (not shown) as will be explained in more detail below.

The precision platen 2 comprises a high precision hard-chrome plated brass plate. It has a front side 4 and a back side 6. The front side 4 comprises a planar contact surface 8 which merges into chamfers 8a and 8b on opposite ends in a longitudinal direction of the platen 2.

Its periperhal contour is substantially similar to the peripheral contour of the cartridge platen in the film cartridge (not shown). Since such super-8-film cartridges as made and sold e.g. by Kodak as well as super-8-film cameras have been known for a long time, they are not shown and will be described only inasmuch as they are of importance for an understanding of the present invention.

As shown in FIG. 1 the precision platen 2 is of a substantially rectangular periphery comprising lateral edges 10, 12 extending in a longitudinal direction and lateral edges 14, 16 extending in a transverse direction. Each of the lateral edges 10, 12 has a pair of lateral extensions 18a, 18b and 20a, 20b. The extensions 18a, 20a are disposed opposite to each other in a central area of the precison platen 2, and the extensions 18b, 20b are disposed in diametrically opposed comer areas of the lateral edges 10, 12. As shown in FIG. 3, the extensions 18a, 18b and 20a, 20b are slightly offset with respect to the plane of the planar abutment surface 8. They are precise contact surfaces to provide for four-point contact on the cartridge platen (not shown) as will be explained in more detail below.

As further shown in FIG. 1, the lateral edge 10 of the precision platen 2 is provided with a pair of recesses 24a, 24b, while the lateral edge 12 is provided with a recess 22. Furthermore, the back side 6 of the precision platen 2 is integrally formed with a longitudinally extending rib 26. The rib 26 is interrupted by a gap in the area of the extensions 18a, 20a so that the rib 26 comprises a pair of separate rib portions 26a and 26b. The rib 26 provides, on the one hand, for stiffening of the precision platen 2 and, on the other hand, for guidance of the precision platen 2 in the cartridge platen so as to prevent transverse movements therebetween. The height of the rib 26 is less than the depth of associated recesses of the cartridge platen (not shown) so as not to interfere with the four-point-contact between the extensions 18a, 18b, 20a, 20b and the cartridge platen (not shown).

It is to be noted that the rib portion 26b could be extended towards the lateral edge 16 so as to enhance the stiffeness of the precision platen 2 and to improve the guidance of the precision platen 2 within the cartridge platen.

As already mentioned. the precison platen 2 as shown is to be used in a super-8-film cartridge. Its thickness is preferably in the range from 0.45 to 0.50 mm. Its length (i.e. the distance between the lateral edges 14 and 16) is e.g. approximately 26 mm, while its width (i.e. the distance between the lateral edges 10 and 12) is approximately 7.6 mm. The total width (distance between the outer edges of the extensions 18a, 20a) is in the order of 10.5 mm. The height of the rib 26 is e.g. 1.3 to 1.4 mm.

Operation of the precision platen 2 will now be described.

As is well known, a super-8-film cartridge has an own platen disposed in the area of an opening of the film cartridge, with the film running along such platen during operation of the film camera. The cartridge platen is biassed by spring force in an outward direction such that it engages a housing wall of the film cartridge when the film cartridge has not been inserted into the film camera. When the film cartridge has been inserted into a super-8-film camera, the cartridge platen has projections engage a film platform in the film camera so that the film is urged against a contact surface of the film platform by the cartridge platen. As far as described so far, the super-8-film cartridge and the super-8-film camera are of conventional design.

The precision platen 2 of the present invention and as shown in FIGS. 1 to 3 is manually inserted into a super-8-film cartridge so as to be positioned between the cartridge platen and the film. As already mentioned the lateral extensions 18a, 18b and 20a, 20b provide for a four-point-contact between the precision platen 2 and the cartridge platen. The rib 26 comprising rib portions 26a, 26b projects into respective recesses of the cartridge platen so as to prevent the precision platen 2 from moving transversely relative to the cartridge platen. The planar contact surface 8 contacts the back side of the film.

When now the film cartridge including the precision platen 2 is inserted into the film camera, the cartridge platen and the precision platen 2 come into engagement with the film platform of the film camera. More precisely, projections of the film platform engage into the recesses 22 and 24a, 24b of the precision platen 22 (as well as into corresponding recesses of the cartridge platen), whereby both platens are fixedly positioned on the film platform of the film camera, The precision platen 2 is urged outwards by the cartridge platen and the spring force acting thereupon so that the planar contact surface 8 of the precision platen 2 urges the film against the respective contact surface of the film platform of the film camera.

This provides for precise contact and guidance of the film on and along the film platform which is further improved by increased compression of the biassing spring in the film cartridge. This avoids any jittering effect of the film running through the film camera as present in the prior art, and results in steady and smooth running of the film, optimal picture steadiness both in horizontal and vertical directions, and uniform picture focussing across the total film width.

What is claimed is:

1. A precision platen for a film cartridge including a cartridge platen biassed by a spring force so as to urge a film against a film platform of a film camera, the precision platen being of a design such that it is manually insertable into said film cartridge between said cartridge platen and said film in order to provide for planar engagement and precise guidance of the film along the film platform of the film camera.

2. The precision platen of claim 1 which has a front side comprising a planar abutment surface for engagement with the film.

3. The precision platen of claim 1 for a film cartridge including a cartridge platen of a predetermined peripheral contour, the precision platen having a peripheral contour substantially corresponding to the peripheral contour of said cartridge platen.

4. The precision platen of claim 1 comprising a pair of lateral edges which are parallel to a film running direction when the film cartridge and the precision platen are inserted in the film camera, and each of which is provided with a pair of extensions for four-point contact thereof on said cartridge platen.

5. The precision platen of claim 5 wherein two of said extensions are disposed opposite to each other in a central area of the precision platen and the remaining two extensions are disposed on diametrically opposite corners of the precision platen.

6. The precision platen of claim 1 having a back side provided with at least one rib which projects into a mating depression of the cartridge platen when the precision platen is inserted into the film cartridge, with the height of the rib being smaller than the depth of the depression.

7. The precision platen of claim 6 wherein the rib extends along the film running direction when the film cartridge and the precision platen have been inserted in the film camera, and the rib is divided into a pair of separate ribs portions by a gap therebetween.

8. The precision platen of claim 1 which is made of metal.

9. The precision platen of claim 8 which comprises a hard-chrome plated brass plate.

10. The precision platen of claim 1 which is of a thickness in the range of 0.45 to 0.50 mm.

11. The precision platen of claim 1 adapted to be used in a super-8-film cartridge.
